(19) United States
(12) Patent Application Publication
(10) Pub. No.: US 2008/0252820 A1
(43) Pub. Date: Oct. 16, 2008

(54) Phase difference compensation film, display panel assembly having the compensation film and method of manufacturing the same

(75) Inventor: Byeong-Seob Ban, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/082,648

(22) Filed: Apr. 11, 2008

(30) Foreign Application Priority Data
Apr. 12, 2007 (KR) 10-2007-0036032

(51) Int. Cl. G02F 1/13363

(52) U.S. Cl. 349/75; 349/193

(57) ABSTRACT

A phase difference compensation layer is positioned between first and second protection films. Discotic liquid crystals of the phase difference compensation layer are tilted relative to a first protection film. The phase difference compensation film further includes an alignment layer formed on the first and the second protection films. The alignment layer substantially aligns the discotic liquid crystals in one direction. The first and the second protection films have a phase axis forming an angle of about 45° relative to an alignment direction of the discotic liquid crystals respectively. The display panel assembly includes a display panel, a lower phase difference compensation film and an upper phase difference compensation film. Therefore, the protection film protects and substantially aligns the discotic liquid crystals in uniform direction.

### CROSS-REFERENCE TO RELATED APPLICATIONS

The present application claims the benefit of priority under 35 U.S.C. §119 of Korean Patent Application No. 10-2007-36032, filed on Apr. 12, 2007 in the Korean Intellectual Property Office (KIPO), the contents of which are herein incorporated by reference in their entirety.

### BACKGROUND OF THE INVENTION

1. Field of the Invention

The present invention relates to a phase difference compensation film, a display panel having the phase difference compensation film and a method of manufacturing the phase difference compensation film. More particularly, the present invention relates to a phase difference compensation film used in a display device, a display panel assembly having the phase difference compensation film, which is capable of improving an image display quality, and a method of manufacturing the phase difference compensation film.

2. Description of the Related Art

A liquid crystal display (LCD) device includes a display panel assembly for displaying information and a backlight assembly for supplying light to the display panel assembly. The display panel assembly includes a liquid crystal display panel wherein an applied electric field changes an alignment of liquid crystals to vary light transmittance, a lower polarization film positioned under the liquid crystal display panel and an upper polarization film positioned over the liquid crystal display panel.

The liquid crystal display panel may be designed to operate in optically compensated bend (OCB) mode to improve a response speed. When light passes through the liquid crystal display panel operated in the OCB mode, a phase difference occurs between light that has traveled along different paths. Thus the display panel assembly may further include a phase difference compensation film to compensate the phase difference. The phase difference compensation film may be conventionally positioned between the liquid crystal display panel and the lower polarization film, and between the liquid crystal display panel and the upper polarization film.

The phase difference compensation film may include a layer of discotic liquid crystal material. The discotic liquid crystals may be aligned uniformly to compensate the phase difference of the light passing through the liquid crystal display panel along different paths. However, external physical and chemical effects may alter the alignment of the discotic liquid crystals so that the alignment becomes non-uniform.

Thus, when the external effects cause non-uniformity in the alignment of the discotic liquid crystals, the phase delay of light passing through the phase difference compensation film may not be uniformly compensated and may vary in accordance with position of the phase difference compensation film. Thus, a display quality of the liquid crystal display device may deteriorate.

### SUMMARY OF THE INVENTION

The present invention provides a phase difference compensation film capable of improving a display quality with uniformly aligned discotic liquid crystals.

The present invention also provides a display panel assembly having the phase difference compensation film.

The present invention also provides a method of manufacturing the phase difference compensation film.

A phase difference compensation film in accordance with one aspect of the present invention includes a first protection film having a first surface extending in a first plane, a second protection film having a second surface extending in a second plane, the second surface of the second protection film facing the first surface of the first protection film and a phase difference compensation layer.

The phase difference compensation layer is positioned between the first surface of the first protection film and the second surface of the second protection film. The phase difference compensation layer includes a plurality of discotic liquid crystals, the discotic liquid crystals each having a surface tilted at a tilt angle relative to the first surface of the first protection film.

The tilt angle is in a range from about 30° to about 60°. A thickness of the phase difference compensation layer is in a range of about 1.0 μm to about 2.0 μm.

The plurality of discotic liquid crystals is tilted substantially at a common angle relative to the first surface of the first protection film. The common angle may be in a range from about 40° to about 45°.

The tilt angle of a discotic liquid crystal may be a function of a distance between the first surface and a location of the discotic liquid crystal.

The tilt angle of the discotic liquid crystals may be increased gradually from the first protection film toward the second protection film.

The phase difference compensation film may further include a first alignment layer formed on the first surface of the first protection film and a second alignment layer formed on the second surface of the second protection film. The first alignment layer and the second alignment layer substantially align the discotic liquid crystals in one direction.

The first protection film and the second protection film each have a phase axis, each phase axis forming an angle of about 45° relative to an alignment direction of the discotic liquid crystals.

The first protection film and the second protection film include a polymer film capable of transmitting light. The polymer film may include a triacetyl-cellulose (TAC) film.

The display panel assembly in accordance with another aspect of the present invention includes a display panel adapted to display information, a first phase difference compensation film positioned on a first side of the display panel.

The first phase difference compensation film includes a first protection film positioned on the first side of the display panel, the first protection film having a first surface extending in a first plane, a second protection film positioned adjacent to the first protection film, the second protection film having a second surface extending in a second plane, and a first phase difference compensation layer positioned between the first surface of the first protection film and the second surface of the second protection film. The phase difference compensation layer includes a first plurality of discotic liquid crystals, each liquid crystal having a surface tilted by a tilt angle relative to the second surface of the second protection film.

A second phase difference compensation film is positioned on a second side of the display panel and includes a third protection film positioned on a second side of the display panel, the third protection film having a third surface extending in a third plane, a fourth protection film positioned adjacent the third protection film, the fourth protection film having a fourth surface extending in a fourth plane, and a second phase difference compensation layer positioned between the third surface of the third protection film and the fourth surface of the fourth protection film. The second phase difference compensation layer includes a second plurality of discotic liquid crystals each liquid crystal having a surface tilted at a tilt angle relative to the fourth surface of the fourth protection film.

A tilt angle of the first plurality of discotic liquid crystals is in a range from about 30° to about 60° and a tilt angle of the second plurality of discotic liquid crystals is in a range from about 30° to about 60°.

A thickness of each of the first and the second phase difference compensation layers is in a range from about 1.0 μm to about 2.0 μm.

The liquid crystals in the first plurality of discotic liquid crystals may be tilted substantially at a common angle relative to the second surface of the second protection film, and the liquid crystals in the second plurality of discotic liquid crystals may be tilted substantially at a common angle relative to the fourth surface of the fourth protection film.

Alternatively, the tilt angle of the discotic liquid crystals in the first plurality of discotic liquid crystals may be gradually increased in size from the second protection film toward the first protection film, and the tilt angle of the discotic liquid crystals in the second plurality of discotic liquid crystals may be gradually increased in size from the fourth protection film toward the third protection film.

The first phase difference compensation film further includes a first alignment layer formed on the first protection film and a second alignment layer formed on the second protection film. The first and second alignment layers substantially align the first plurality of discotic liquid crystals in one direction. The second phase difference compensation film further includes a third alignment layer formed on the third protection film and a fourth alignment layer formed on the fourth protection film. The third alignment layer and the fourth alignment layer substantially align the second plurality of discotic liquid crystals in the one direction.

First phase axis of each of the first and the second protection films may form an angle of about 450 relative to the one direction. A second phase axis of each of the third and the fourth protection films may form an angle of about 45° relative to the one direction. The second phase axis may be substantially perpendicular to the first phase axis.

The display panel assembly further includes a first polarization film positioned on the first side of the display panel, the first phase difference compensation film being positioned between the display panel and the first polarization film, and a second polarization film positioned on the second side of the display panel, the second phase difference compensation film being positioned between the display panel and the second polarization film.

A first polarization axis of the first polarization film may be substantially parallel to the first phase axis and a second polarization axis of the second polarization film may be substantially parallel to the second phase axis.

The display panel assembly wherein the display panel includes an array substrate positioned opposite to the first phase difference compensation film, an opposite substrate positioned opposite to the array substrate, the opposite substrate being positioned opposite the second phase difference compensation film and a liquid crystal layer positioned between the array substrate and the opposite substrate, the liquid crystal layer being operated in optically compensated bend (OCB) mode.

The liquid crystal layer comprises a plurality of liquid crystals, the plurality of liquid crystals being aligned in the one direction.

The method of manufacturing the phase difference compensation film in accordance with still another aspect of the present invention includes forming a first alignment layer on a first protection film having a first surface extending in a plane and having a first phase axis and forming a second alignment layer on a second protection film having a second phase axis, rubbing the first and second alignment layers in one direction, and disposing a phase difference compensation layer comprising discotic liquid crystals between the first protection film and the second protection film. The discotic liquid crystals are substantially aligned in the one direction and each discotic liquid crystal having a surface tilted at a tilt angle relative to the first surface of the first protection film.

The one direction forms an angle of about 45° relative to the first phase axis and relative to the second phase axis.

The method of manufacturing a phase difference compensation film may further include curing the phase difference compensation layer between the first protection film and the second protection film.

A tilt angle of the discotic liquid crystals relative to the first protection film may be in a range of about 30° to about 60°.

According to the present invention, the display panel assembly having the phase difference compensation film and the method of manufacturing the same, depend on the first and the second protection films included in the phase difference compensation film to protect and align the discotic liquid crystals in a predetermined uniform direction. Thus, display quality may be protected from deterioration arising from externally induced non-uniformity in an alignment direction of the discotic liquid crystals.

### BRIEF DESCRIPTION OF THE DRAWINGS

The above and other advantages of the present invention will become more apparent in light of the detailed description of exemplary embodiments thereof taken together with the accompanying drawings, in which:

FIG. 1 is an expanded perspective view illustrating a display panel assembly in accordance with an exemplary embodiment of the present invention;

FIG. 2 is an expanded perspective view illustrating a unit cell of a display panel assembly in accordance with an exemplary embodiment of the present invention;

FIG. 3 is a diagram illustrating a relationship between a phase axis of a protection film in a phase difference compensation film and an alignment direction of discotic liquid crystals in accordance with an exemplary embodiment of the present invention;

FIG. 4 is a perspective view illustrating a lower phase difference compensation film included in a display panel assembly in accordance with an exemplary embodiment of the present invention;

FIG. 5 is a cross-sectional view illustrating the lower phase difference compensation film taken along a line I-I′ in FIG. 4;

FIG. 6 is a cross-sectional view illustrating a lower phase difference compensation film included in a display panel assembly in accordance with an exemplary embodiment of the present invention;

FIG. 7 is a graph showing light transmittance versus pixel voltage in a display panel assembly in accordance with an exemplary embodiment of the present invention; and

FIG. 8 is a flow chart illustrating a method of manufacturing a phase difference compensation film in accordance with an exemplary embodiment of the present invention.

### DESCRIPTION OF THE EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

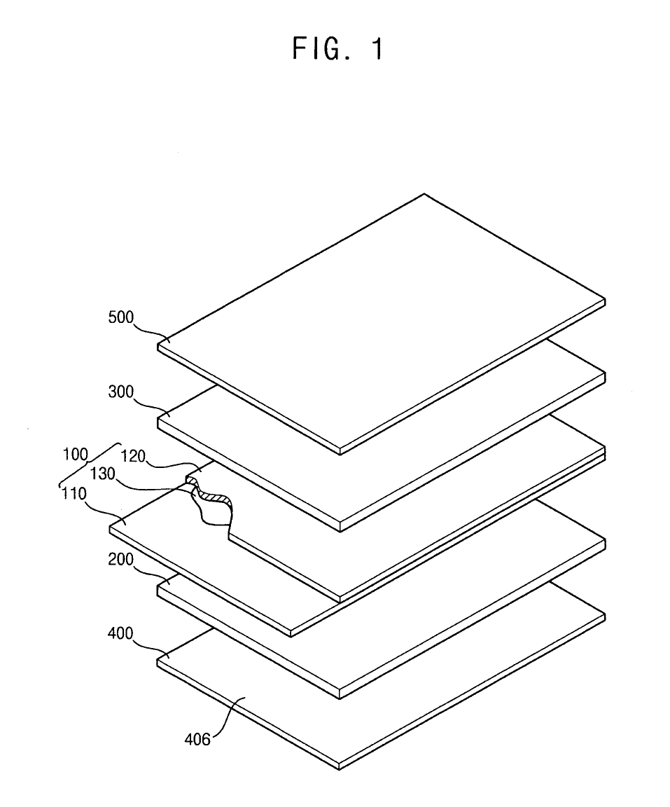

FIG. 1 is an expanded perspective view of a display panel assembly in accordance with an exemplary embodiment of the present invention.

Referring to FIG. 1, the display panel assembly includes a display panel 100, a lower phase difference compensation film 200, an upper phase difference compensation film 300, a lower polarization film 400 and an upper polarization film 500.

The display panel 100 includes an array substrate 110, an opposite substrate 120 and a panel liquid crystal layer 130.

The array substrate 110 includes a plurality of signal lines (not shown), a plurality of thin film transistors (not shown) electrically connected to the signal lines, and a plurality of pixel electrodes (not shown) electrically connected to the thin film transistors.

The opposite substrate 120 is positioned opposite to the array substrate 110. The opposite substrate 120 includes a plurality of color filters (not shown), a planarization layer (not shown) and a common electrode (not shown). The color filters correspond to the pixel electrodes, respectively. The planarization layer covers the color filters, and the common electrode is formed on the planarization layer.

The panel liquid crystal layer 130 is positioned between the array substrate 110 and the opposite substrate 120. An electric field may be applied between a pixel electrode and the common electrode to change an alignment of liquid crystals in the panel liquid crystal layer 130. Thus, the light transmittance of a pixel in the display panel assembly may be changed corresponding to the changed alignment of the liquid crystals in the panel liquid crystal layer 130.

The lower phase difference compensation film 200 is positioned under the display panel 100. The upper phase difference compensation film 300 is positioned over the display panel 100. Light passing through the display panel 100 may have a phase difference arising from different paths of the light through the panel liquid crystal layer 130. The lower phase difference compensation film 200 and the upper phase difference compensation film 300 serve to compensate the phase difference of the light to improve a viewing angle of the display panel 100.

The lower polarization film 400 is positioned under the lower phase difference compensation film 200. The lower polarization film 400 polarizes incident light along lower polarization axis 405, which is hereinafter sometimes referred to as the first direction. The first direction may be referred to as an arbitrary direction parallel to a surface 406 of the lower polarization film 400. For example, the first direction may be substantially parallel to a diagonal line of the lower polarization film 400.

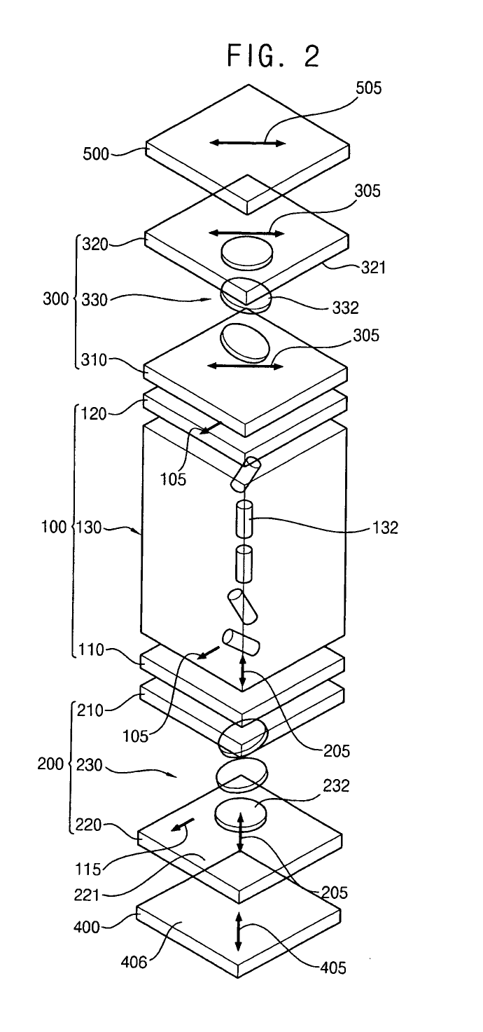

The upper polarization film 500 is positioned over the upper phase difference compensation film 300. The upper polarization film 500 polarizes light passing through the display panel 100 along upper polarization axis 505 as shown in FIG. 2, sometimes referred to herein as the second direction. The second direction may be substantially perpendicular to the first direction.

FIG. 2 is an expanded perspective view of a unit cell of a display panel assembly in accordance with an exemplary embodiment of the present invention.

Referring to FIGS. 1 and 2, the panel liquid crystal layer 130 may include a plurality of panel liquid crystals 132. Each of the panel liquid crystals 132 may have a rod shaped structure. In exemplary embodiments, the panel liquid crystal layer 130 is operated in an optically compensated bend (OCB) mode to improve a response speed thereof.

When an electric field is not applied between the array substrate 110 and the opposite substrate 120, an alignment of the panel liquid crystals 132 may gradually vary from the array substrate 110 toward the opposite substrate 120. For example, starting at the array substrate and moving towards the opposite substrate, the panel liquid crystals 132 may tilt by a predetermined angle relative to the array substrate 110, and then the panel liquid crystals 132 may tilt along a direction substantially perpendicular to the array substrate 110 and the opposite substrate 120, and then the panel liquid crystals 132 may tilt by a predetermined angle relative to the opposite substrate 120.

When an electric field is applied between the array substrate 110 and the opposite substrate 120, most of the panel liquid crystals 132 may be aligned substantially perpendicular to the array substrate 110 or the opposite substrate 120 except for some of the panel liquid crystals 132 adjacent to the array substrate 110 and some of the panel liquid crystals 132 adjacent to the opposite substrate 120.

In exemplary embodiments of the present invention, a first panel alignment layer (not shown) is formed on the array substrate 110, and a second panel alignment layer (not shown) is formed on the opposite substrate 120. The second panel alignment layer faces the first panel alignment layer. A first panel alignment controlling surface and a second panel alignment controlling surface may be formed on the first panel alignment layer and the second panel alignment layer, respectively. The first and the second panel alignment controlling surfaces may be formed by a rubbing process. Here, a rubbing direction of the first panel alignment layer may be substantially parallel to a rubbing direction of the second panel alignment layer.

The panel liquid crystals 132 are substantially aligned along one direction determined by the first and the second panel rubbing directions. In the OCB mode, the alignment direction of the panel liquid crystals 132 may be referred to as a panel alignment direction 105. Thus, a panel alignment direction 105 may be substantially parallel to the rubbing directions of the first panel alignment layer and the second panel alignment layer.

Referring now to FIGS. 1 and 2, the lower phase difference compensation film 200 includes a first lower protection film 210, a second lower protection film 220 and a lower phase difference compensation layer 230.

The first lower protection film 210 is positioned under the display panel 100. In particular, the first lower protection film 210 is positioned under the array substrate 110. The second lower protection film 220 faces the first lower protection film 210. The second lower protection film 220 is positioned under the first lower protection film 210.

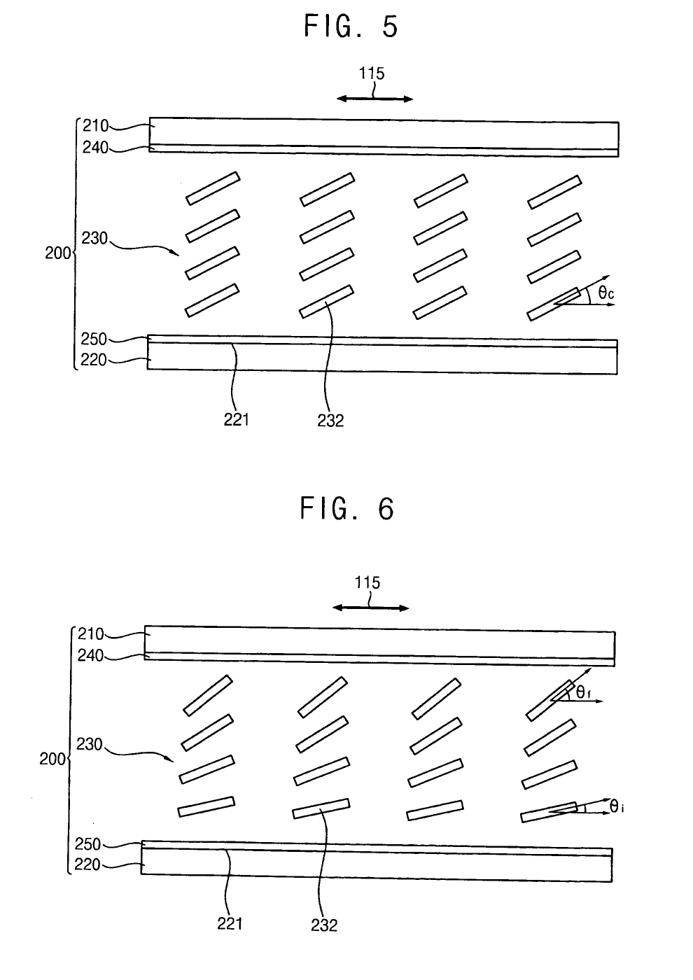

The lower phase difference compensation layer 230 is positioned between the first lower protection film 210 and the second lower protection film 220. The lower phase difference compensation layer 230 includes discotic liquid crystals 232 of circular disc shape. The discotic liquid crystals 232 are tilted relative to surface 221 of the second lower protection film 220. The tilt angle is illustrated in FIG. 5 and explained in more detail below.

The upper phase difference compensation film 300 includes a first upper protection film 310, a second upper protection film 320 and an upper phase difference compensation layer 330.

The first upper protection film 310 is positioned over the display panel 100. In particular, the first upper protection film 310 is positioned over the opposite substrate 120. The second upper protection film 320 is opposite to the first upper protection film 310. The second upper protection film 320 is positioned over the first upper protection film 310.

The upper phase difference compensation layer 330 is positioned between the first upper protection film 310 and the second upper protection film 320. The upper phase difference compensation layer 330 includes a plurality of upper discotic liquid crystals 332 of circular disc shape. The upper discotic liquid crystals 332 are tilted relative to surface 321 of the second upper protection film 320.

The lower polarization film 400 is positioned under the lower phase difference compensation film 200. In particular, the lower polarization film 400 is positioned under the second lower protection film 220. The lower polarization film 400 has a polarization axis indicated by 405 in FIG. 2. The lower polarization film 400 polarizes light passing through the lower polarization film 400.

The upper polarization film 500 is positioned over the upper phase difference compensation film 300. In particular, the upper polarization film 500 is positioned over the second upper protection film 320. The upper polarization film 500 has an upper polarization axis 505 parallel to the second direction. Thus, the upper polarization film 500 polarizes light passing through the upper polarization film 500 in the second direction substantially parallel to the upper polarization axis 505. In exemplary embodiments, the lower polarization axis 405 is substantially perpendicular to the upper polarization axis 505.

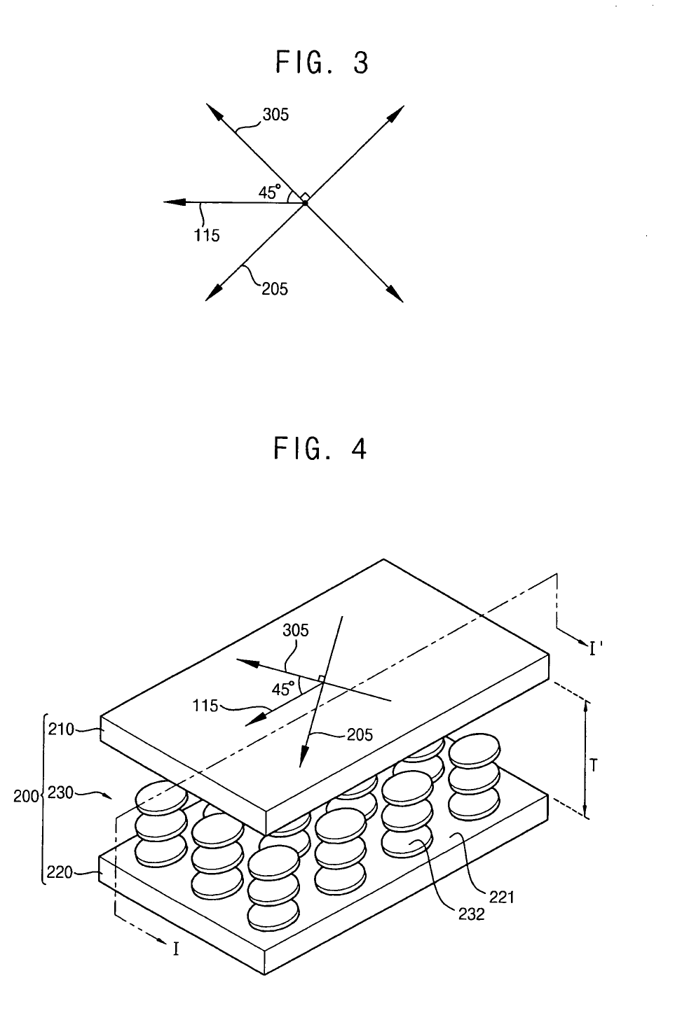

FIG. 3 is a diagram illustrating a relationship between phase axes of the protection films in the phase difference compensation films and the alignment direction of discotic liquid crystals in accordance with exemplary embodiments of the present invention. The relationship between the phase axes and the alignment direction illustrated in FIG. 3 includes the lower phase difference compensation film 200 and the upper phase difference compensation film 300 illustrated in FIG. 2.

Referring to FIGS. 2 and 3, the first lower protection film 210 and the second lower protection film 220 each include a transparent polymer film. For example, the first lower protection film 210 and the second lower protection film 220 may each include a triacetyl-cellulose (TAC) film. Each of the first lower protection film 210 and the second lower protection film 220 has a lower phase axis 205 substantially parallel to the lower polarization axis 405 of the lower polarization film 400.

The first upper protection film 310 and the second upper protection film 320 each include a transparent polymer film. For example, the first upper protection film 310 and the second upper protection film 320 may each include a triacetyl-cellulose (TAC) film. Each of the first upper protection film 310 and the second upper protection film 320 has an upper phase axis 305 substantially parallel to the upper polarization axis 505 of the upper polarization film 500.

The lower discotic liquid crystals 232 positioned between the first lower protection film 210 and the second lower protection film 220 are substantially aligned in one direction. The upper discotic liquid crystals 332 positioned between the first upper protection film 310 and the second upper protection film 320 are substantially aligned in a direction substantially the same as the alignment direction of the lower discotic liquid crystals 232.

The common alignment direction of the lower discotic liquid crystals 232 and the upper discotic liquid crystals 332 is referred to as the compensation alignment direction 115. The compensation alignment direction 115 is substantially the same as the panel alignment direction 105, and the compensation alignment direction 115 forms an angle of about 45° with the lower phase axis 205 and the upper phase axis 305 as shown in FIG. 3.

As described above, in exemplary embodiments, the first lower protection film 210 and the second lower protection film 220 align the lower discotic liquid crystals 232 substantially with one direction, and the first upper protection film 310 and the second upper protection film 320 align the upper discotic liquid crystals 332 with a direction substantially parallel to the one direction. The lower phase axis 205 is substantially parallel to the lower polarization axis 405; the upper phase axis 305 is substantially parallel to the upper polarization axis 505, and the compensation alignment direction 115 forms an angle of about 45° with the lower phase axis 205 and the upper phase axis 305. Then, when light passes through the first lower protection film 210 and the second lower protection film 220 or the first upper protection film 310 and the second upper protection film 320, a phase difference of the light may be minimized.

FIG. 4 is a perspective view illustrating a lower phase difference compensation film included in a display panel assembly in accordance with an exemplary embodiment of the present invention. FIG. 5 is a cross-sectional view illustrating the lower phase difference compensation film taken along a line I-I′ in FIG. 4.

Referring to FIGS. 4 and 5, the lower phase difference compensation film 200 further includes a first lower alignment layer 240 and a second lower alignment layer 250.

The first lower alignment layer 240 is formed on the first lower protection film 210. The second lower alignment layer 250 is formed on the second lower protection film 220. The second lower alignment layer 250 faces the first lower alignment layer 240.

In exemplary embodiments of the present invention, a first lower alignment controlling surface (not shown) may be formed on the first lower alignment layer 240, and a second lower alignment controlling surface (not shown) may be formed on the second lower alignment layer 250 by using a rubbing process. Rubbing directions of the first lower alignment layer 240 and the second lower alignment layer 250 may be substantially parallel to the rubbing directions of the first panel alignment layer and the second panel alignment layer, respectively. Thus, the rubbing directions of the first lower alignment layer 240 and the second lower alignment layer 250 may be substantially parallel to the compensation alignment direction 115. Thus, the lower discotic liquid crystals 232 may be aligned in the compensation alignment direction 115 shown in FIG. 4.

Referring to FIG. 5, the lower discotic liquid crystals 232 are tilted relative to surface 221 of the second lower protection film 220. The tilt angle of the lower discotic liquid crystals 232 relative to surface 221 of the second lower protection film 220 may be in a range from about 30° to about 60°. The lower discotic liquid crystals shown in FIG. 5 are tilted in the plane of the paper in a direction that is called the alignment direction of the lower discotic crystals.

The lower discotic liquid crystals 232 may be mutually tilted at an angle θc relative to surface 221 of the second lower protection film 220. The angle θc may be in a range from about 40° to about 45° and may be referred to as a common angle.

The thickness T of the lower phase difference compensation layer 230 may be in a range from about 1.0 μm to about 2.0 μm.

In like fashion the upper phase difference compensation film 300 shown in FIG. 2 further includes a first upper alignment layer (not shown) and a second upper alignment layer (not shown).

The first upper alignment layer is formed on the first upper protection film 310. The second upper alignment layer is formed on the second upper protection film 320. The second upper alignment layer faces the first upper alignment layer.

In exemplary embodiments of the present invention, a first upper alignment controlling surface may be formed on the first upper alignment layer, and a second upper alignment controlling surface may be formed on the second upper alignment layer by using a rubbing process. Rubbing directions of the first upper alignment layer and the second upper alignment layer may be substantially the same as the rubbing directions of the first panel alignment layer and the second panel alignment layer, respectively. Thus, the upper discotic liquid crystals may be aligned in the compensation alignment direction 115 shown in FIG. 4.

The upper discotic liquid crystals 332 are tilted relative to the second upper protection film 320. For example, the tilt angle of the upper discotic liquid crystals 332 relative to surface 321 of the second upper protection film 320 may be in a range from about 30° to about 60°.

In the manner as shown in FIG. 5 for the lower discotic liquid crystals 232, the upper discotic liquid crystals 332 may be mutually tilted substantially by a same angle relative to surface 321 of the second upper protection film 320. The same angle may be in a range from about 40° to about 45° and may be referred to as a common angle.

The thickness of the upper phase difference compensation layer may be in a range from about 1.0 μm to about 2.0 μm.

FIG. 6 is a cross-sectional view illustrating a lower phase difference compensation film included in a display panel assembly in accordance with exemplary embodiments of the present invention. The lower phase difference compensation film 200-1 in FIG. 6 may be substantially the same as the lower phase difference compensation film 200 in FIG. 5 except for an alignment configuration of the lower discotic liquid crystals 232.

Referring to FIG. 6, the lower discotic liquid crystals 232 are tilted relative to surface 221 of the second lower protection film 220. The tilt angle of the lower discotic liquid crystals 232 relative to surface 221 is gradually increased in size from the second lower protection film 220 toward the first lower protection film 210. The tilt angle of the lower discotic liquid crystals 232 may be in a range from about 30° about 60°.

In exemplary embodiments of the present invention, the lower discotic liquid crystals 232 adjacent to the second lower protection film 220 may be tilted by a first angle θi relative to surface 221 of the second lower protection film 220, and the lower discotic liquid crystals 232 adjacent to the first lower protection film 210 may be tilted by a second angle Of relative to surface 221 of the second lower protection film 220. Thus, the tilt angle of the lower discotic liquid crystals 232 may be increased gradually in a range from about the first angle θi to the second angle θf. For example, the first angle θi may be about 30°, and the second angle θf may be about 60°.

In exemplary embodiments of the present invention, the upper discostic liquid crystals 332 and the lower discostic liquid crystals 232 are configured symmetrically with respect to the display panel 100. The tilt angle of the upper discotic liquid crystals 332 relative to surface 321 of the second upper protection film 320 may be increased gradually from the second upper protection film 320 toward the first upper protection film 310. The tilt angle of the upper discotic liquid crystals 332 may be in a range from about 30° to about 60°.

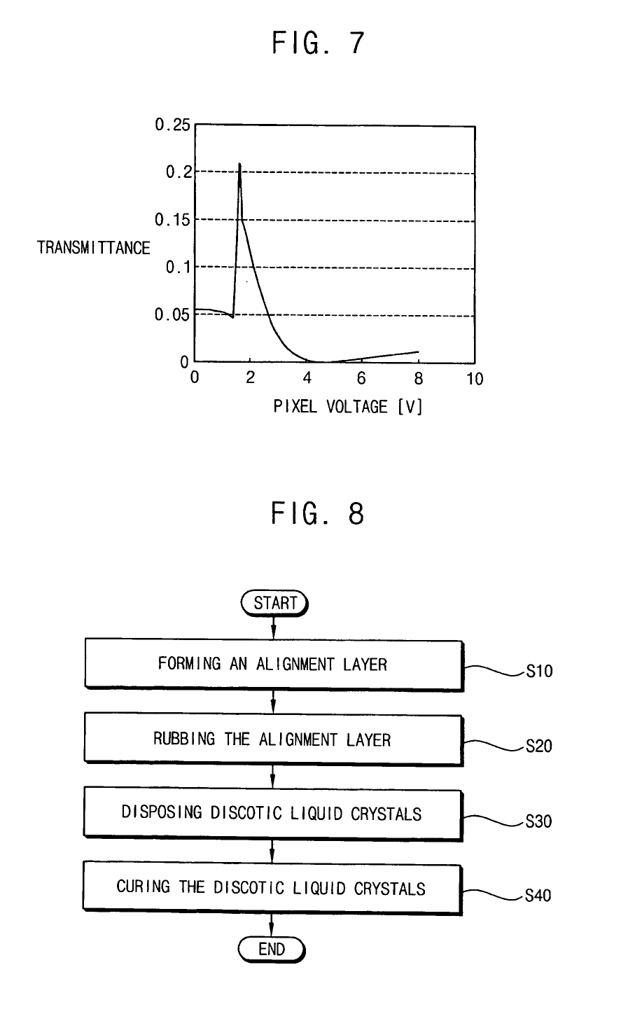

FIG. 7 is a graph illustrating a variation of light transmittance versus pixel voltage in a display panel assembly in accordance with exemplary embodiments of the present invention.

Referring to FIG. 7, as the pixel voltage applied to a pixel electrode in the array substrate is increased, the light transmittance of the pixel increases to a maximum and then decreases. The display panel assembly has a maximum light transmittance, when the pixel voltage is about a white gray voltage Vw. The display panel assembly has a minimum light transmittance, when the pixel voltage is about a black gray voltage Vb. The maximum light transmittance may be about 0.22, and the minimum light transmittance may be about zero. Thus, as the pixel voltage is increased in a range from the white gray voltage Vw to the black gray voltage Vb, the light transmittance of the display panel assembly is decreased from about 0.22 to about zero.

In exemplary embodiments of the present invention, the white gray voltage Vw may be fixed at about 1.7V, however, the black gray voltage Vb may vary depending on various external conditions. For example, the black gray voltage Vb may vary corresponding to the tilt angles of the lower discotic liquid crystals and the upper discotic liquid crystals.

The black gray voltage Vb may be about 6.7V, when the tilt angles of the lower discotic liquid crystals and the upper discotic liquid crystals are about 33.89°. The black gray voltage Vb may be about 4.7V, when the tilt angles of the lower discotic liquid crystals and the upper discotic liquid crystals are about 43.88°. Thus, the display panel assembly may be operated at the lower black gray voltage Vb, when the tilt angles may be about 43.88°.

In general, the lower and the upper discostic liquid crystals may be aligned irregularly owing to an external condition, and the tilt angles of the lower discostic liquid crystals and the upper discostic liquid crystals may vary owing to external physical and chemical contacts, when the lower and the upper discotic liquid crystals are not protected by the first lower and the second lower protection film and the first upper and the second upper protection film. Such a problem may occur, when the lower discotic liquid crystals are protected by only one of the first lower protection film and the second lower protection film or when the upper discotic liquid crystals are protected by only one of the first upper protection film and the second upper protection film.

Furthermore, the black gray voltage or a contrast ratio may vary depending on a position in the display panel, when the tilt angles of some of the lower and the upper discotic liquid crystals vary owing to external contact. As a result, display quality of the display panel may be decreased.

In exemplary embodiments of the present invention, the first and the second lower protection films protect the lower discotic liquid crystals to fix the alignment direction of the lower discotic liquid crystals, and the first and the second upper protection films protect the upper discotic liquid crystals to fix the alignment direction of the upper discotic liquid crystals, so that the alignment direction of the lower and the upper discotic liquid crystals are not apt to change owing to external effects.

FIG. 8 is a flow chart illustrating a method of manufacturing a phase difference compensation film in accordance with exemplary embodiments of the present invention.

Referring to FIG. 8, a first protection alignment layer is formed on the first protection film, and a second protection alignment layer is formed on the second protection film in step S10.

A first protection alignment controlling surface may be formed on the first protection alignment layer by a rubbing process applied along one direction, and a second protection alignment controlling surface may be formed on the second protection alignment layer by a rubbing process applied along the one direction in step S20.

Discotic liquid crystals of circular disc shape are disposed between the first and the second protection films, so that the discotic liquid crystals may be tilted relative to the first protection film in step S30. Thus, a phase difference compensation layer is formed between the first and the second protection films. The first and the second protection alignment layers determine an alignment direction and a tilt angle of the discotic liquid crystals.

In exemplary embodiments, the tilt angle of the discotic liquid crystals may be in a range from about 30° to about 60°. The discotic liquid crystals may be mutually tilted at an angle that is substantially the same angle relative to a surface of the first protection film. Alternatively, the tilt angle of the discotic liquid crystals may be increased from the first protection film toward the second protection film. The thickness of the phase difference compensation layer may be in a range from about 1.0 μm to about 2.0 μm.

Finally, the phase difference compensation layer containing discotic liquid crystals is cured in step S40. The curing process fixes the alignment direction of the discotic liquid crystals. For example, the phase difference compensation layer may further include polymer material mixed with the discotic liquid crystals. Then, the phase difference compensation layer between the first and the second protection films is exposed to ultraviolet rays or infrared rays so that the polymer material is cured. The polymer material which is cured may fix the alignment direction of the discotic liquid crystals.

According to the present invention, the alignment direction of the discotic liquid crystals is fixed by the first and the second protection films, thus the alignment direction of the discotic liquid crystals is not apt to change owing to external effect, so that display quality of the display panel assembly may be enhanced.

The present invention has been described with reference to the example embodiments. It is evident, however, that many alternative modifications and variations will be apparent to those having skill in the art in light of the foregoing description. Accordingly, the present invention embraces all such alternative modifications and variations as falling within the spirit and scope of the appended claims.

What is claimed is:

1. A phase difference compensation film comprising:
a first protection film having a first surface extending in a first plane;
a second protection film having a second surface extending in a second plane, the second surface facing the first surface of the first protection film; and
a phase difference compensation layer positioned between the first surface of the first protection film and the second surface of the second protection film, the phase difference compensation layer comprising a plurality of discotic liquid crystals each having a surface tilted by a tilt angle relative to the first surface of the first protection film.

2. The phase difference compensation film of claim 1, wherein the tilt angle is in a range from about 30° to about 60°.

3. The phase difference compensation film of claim 2, wherein a thickness of the phase difference compensation layer is in a range from about 1.0 μm to about 2.0 μm.

4. The phase difference compensation film of claim 2, wherein the plurality of discotic liquid crystals are tilted substantially at a common angle relative to the first surface of the first protection film.

5. The phase difference compensation film of claim 4, wherein the common angle is in a range from about 40° to about 45°.

6. The phase difference compensation film of claim 2, wherein the tilt angle of a discotic liquid crystal is increased when a distance between the first surface and the discotic liquid crystal increases.

7. The phase difference compensation film of claim 1, further comprising a first alignment layer formed on the first surface of the first protection film and a second alignment layer formed on the second surface of the second protection film.

8. The phase difference compensation film of claim 7, wherein the first protection film and the second protection film each have a phase axis, each phase axis forming an angle of about 45° relative to an alignment direction of the discotic liquid crystals.

9. The phase difference compensation film of claim 1, wherein the first protection film and the second protection film each comprise a polymer film capable of transmitting light.

10. The phase difference compensation film of claim 9, wherein the polymer film comprises a triacetyl-cellulose (TAC) film.

11. A display panel assembly comprising:
a display panel adapted to display information;
a first phase difference compensation film positioned on a first side of the display panel, the first phase difference compensation film comprising;
a first protection film positioned on the first side of the display panel, the first protection film having a first surface extending in a first plane;
a second protection film positioned adjacent to the first protection film, the second protection film having a second surface extending in a second plane, the second surface facing the first surface of the first protection film; and
a first phase difference compensation layer positioned between the first surface of the first protection film and second surface of the second protection film, the first phase difference compensation layer comprising a first plurality of discotic liquid crystals, each liquid crystal having a surface tilted by an angle relative to the second surface of the second protection film; and
a second phase difference compensation film positioned on a second side of the display panel, the second phase difference compensation film comprising:
a third protection film positioned on a second side of the display panel, the third protection film having a third surface extending in a third plane;
a fourth protection film positioned adjacent to the third protection film, the fourth protection film having a fourth surface extending in a fourth plane, the fourth surface facing the third surface of the third protection film; and
a second phase difference compensation layer positioned between the third surface of the third protection film and the fourth surface of the fourth protection film, the second phase difference compensation layer comprising a second plurality of discotic liquid crystals, each discotic liquid crystal having a surface tilted by an angle relative to the fourth surface of the fourth protection film.

12. The display panel assembly of claim 11, wherein a tilt angle of the first plurality of discotic liquid crystals is in a range from about 30° to about 60°; and wherein a tilt angle of the second plurality of discotic liquid crystals is in a range from about 30° to about 60°.

13. The display panel assembly of claim 12, wherein the thickness of each of the first and the second phase difference compensation layers is in a range from about 1.0 μm to about 2.0 μm.

14. The display panel assembly of claim 12, wherein the first plurality of discotic liquid crystals are tilted substantially at a common angle relative to the second surface of the second protection film; and
wherein the second plurality of discotic liquid crystals are tilted substantially at a common angle relative to the fourth surface of the fourth protection film.

15. The display panel assembly of claim 12, wherein the tilt angle of the discotic liquid crystals in the first plurality of discotic liquid crystals is gradually increased in size from the second protection film toward the first protection film; and
wherein the tilt angle of the discotic liquid crystals in the second plurality of discotic liquid crystals is gradually increased in size from the fourth protection film toward the third protection film.

16. The display panel assembly of claim 11, wherein the first phase difference compensation film further comprises a first alignment layer formed on the first surface of the first protection film and a second alignment layer formed on the second surface of the second protection film, the first and second alignment layers substantially aligning the first plurality of discotic liquid crystals in one direction; and
wherein the second phase difference compensation film further comprises a third alignment layer formed on the third surface of the third protection film and a fourth alignment layer formed on the fourth surface of the fourth protection film, the third alignment layer and the fourth alignment layer substantially aligning the second plurality of discotic liquid crystals in the one direction.

17. The display panel assembly of claim 16, wherein a first phase axis of each of the first and the second protection films forms an angle of about 45° relative to the one direction; and
wherein a second phase axis of each of the third and the fourth protection films forms an angle of about 45° relative to the one direction, the second phase axis being substantially perpendicular to the first phase axis.

18. The display panel assembly of claim 17, further comprising:
a first polarization film positioned on the first side of the display panel, the first phase difference compensation film being positioned between the display panel and the first polarization film; and
a second polarization film positioned on the second side of the display panel, the second phase difference compensation film being positioned between the display panel and the second polarization film.

19. The display panel assembly of claim 18, wherein a polarization axis of the first polarization film is substantially parallel to the first phase axis; and
wherein a polarization axis of the second polarization film is substantially parallel to the second phase axis.

20. The display panel assembly of claim 16, wherein the display panel comprises:
an array substrate facing the first phase difference compensation film;
an opposite substrate positioned opposite to the array substrate, the opposite substrate facing the second phase difference compensation film; and
a liquid crystal layer positioned between the array substrate and the opposite substrate, the liquid crystal layer being operated in optically compensated bend (OCB) mode.
